(19) United States
(12) Patent Application Publication
(10) Pub. No.: US 2025/0028935 A1
(43) Pub. Date: Jan. 23, 2025

(54) Integrated Denoising Neural Network for High Density Memory

(71) Applicant: Taalas Inc., Toronto (CA)

(72) Inventor: Ljubisa Bajic, Toronto (CA)

(21) Appl. No.: 18/775,368

(22) Filed: Jul. 17, 2024

Related U.S. Application Data
(60) Provisional application No. 63/546,922, filed on Nov. 1, 2023.
(60) Provisional application No. 63/527,825, filed on Jul. 20, 2023.

(51) Int. Cl. G06N 3/0455; G06N 3/084

(52) U.S. Cl. CPC G06N 3/0455; G06N 3/084

(57) ABSTRACT

Methods and systems which involve computer memories are disclosed herein. A memory in accordance with this disclosure can be a multi-value memory in which each storage element of the memory can store multiple values as opposed to a standard binary storage element. The memory can include a decoder neural network and an encoder neural network to denoise the values in the memory. Various approaches disclosed herein overcome design constraints that would otherwise limit the density of such a memory.

### CROSS REFERENCE TO RELATED APPLICATIONS

This application claims the benefit of U.S. Provisional Patent Application No. 63,527,825, filed Jul. 20, 2023, and U.S. Provisional Patent Application No. 63/546,922, filed Nov. 1, 2023, both of which are incorporated by reference herein in their entireties for all purposes.

### BACKGROUND

Neural networks, particularly deep learning models, have proven to be remarkably effective in a wide range of applications, from image recognition to natural language processing. However, one of their notable characteristics is their voracious appetite for parameters. These parameters, essentially the numerical weights that the network uses to make predictions or decisions, are crucial for a network's ability to learn complex patterns from data. As neural networks become more sophisticated and tackle increasingly intricate tasks, the demand for parameters continues to grow. This trend is expected to escalate in the future as researchers and engineers develop even more intricate architectures and strive for higher levels of accuracy and generalization. This increasing parameter count presents challenges in terms of computational resources, energy consumption, and model interpretability, underscoring the need for ongoing research and innovation to strike a balance between model complexity and efficiency.

In addition to the issues mentioned above, the rapid rise in parameter requirements for modern neural networks has also led to a massive increase in the memory resources required to conduct the computations necessary to execute the networks. As such, artificial intelligence accelerators, which are designed to enhance the performance of neural networks and other machine learning tasks, demand substantial memory resources to operate efficiently. These accelerators process vast amounts of data and require quick access to the model weights and intermediate results required for executing a neural network. However, a critical bottleneck arises from the communication between the memory and the processors within artificial intelligence accelerators. While the processors can perform computations at remarkable speeds, fetching data from memory can be a time-consuming operation, leading to idle processor cycles and reduced overall performance. Addressing this memory-processor communication bottleneck is a critical challenge in the field of artificial intelligence hardware design. Innovations like on-chip memory, high-bandwidth memory interfaces, and memory hierarchy optimizations are being pursued to mitigate this limitation, allowing artificial intelligence accelerators to harness their full potential for complex artificial intelligence workloads.

### SUMMARY

Methods and systems which involve computer memories are disclosed herein. Specifically, high density memories with integrated denoising neural networks are disclosed herein. The high-density memories can be integrated with processors and be formed on the same substrate as the processors. The high-density memories can be integrated with an artificial intelligence accelerator or any computational system that requires large amounts of data to execute the workloads of the computational system. The high-density memories can be integrated with a denoising neural network and be formed on the same substrate as the denoising neural network. The denoising neural network can be configured to reduce the impact of various kinds of noise of the high-density memory to thereby assure that a value to be stored in the memory can be later read and recognized as that same value. Using such a denoising neural network, design constraints placed on the memory can be loosened so the memory can be designed to be more dense, lower power, or faster while keeping the same performance in terms of storage fidelity.

In specific embodiments of the invention, high-density memories can be multi-value memories where each storage element is a multi-value storage element which can store any one of multiple values. For example, the values can be stored as one of many conductivity states of a circuit element, connectivity states of a circuit element, amounts of charge stored by a circuit element, or oscillation states of a circuit element. The storage elements can store a multi-bit digital value as one of multiple values in analog form to be read out from a memory array and converted back into the multi-bit digital value. The high-density memories can include noise sources in the form of defects in individual storage elements, cross talk between storage elements in the array, noise during the read operation of the memory that ends up being read by the read circuit, and noise during the write operation of the memory that ends up being written into the storage element. While these noise sources can be found in many memory architectures, they are particularly acute in high-density memories and memories with multi-value storage elements.

In specific embodiments of the invention, the denoising network includes a decoder neural network. In specific embodiments of the invention, the denoising network includes an encoder neural network. In specific embodiments of the invention, the denoising network includes both an encoder neural network and a decoder neural network. The encoder neural network and the decoder neural network can form an autoencoder. In specific embodiments, the encoder neural network, the decoder neural network, and at least one of the noise sources mentioned above can form a variational autoencoder.

Encoder neural networks in accordance with this disclosure can be configured to format the values to be written into the memory to reduce the impact of noise on the storage fidelity of the memory. This formatting can be referred to herein as encoding. Notably, this formatting does not necessarily include reducing the dimensionality of the input to the encoder and the term “encoding” is used herein to mean that the true values have been formatted to counteract the errors and variances in the memory. Indeed, contrary to standard practice, embodiments disclosed herein exhibit beneficial results when the encoder increases the dimensionality of the input to the encoder as is described below. Decoder neural networks in accordance with this disclosure can be configured to format the values as they are read from the memory to reduce the impact of noise on the memory array. This formatting can be referred to herein as decoding. Notably, this formatting does not necessarily include increasing the dimensionality of the input to the decoder and the term “decoding” is used herein to mean that the system is attempting to recover the true value from the memory and counteract errors in the memory. Indeed, contrary to standard practice, embodiments disclosed herein exhibit beneficial results when the decoder decreases the dimensionality of the input to the decoder as is described below.

FIG. 1 illustrates a denoising neural network including encoder neural network 110 and decoder neural network 120 which form an autoencoder to improve the performance of noisy memory 100 in accordance with specific embodiments of the inventions disclosed herein. Noisy memory 100 can be a high-density multi-value memory used in combination with a processor that is conducting computations for a machine learning application in which the memory is being used to store the parameters and activations of the model for the machine learning application. As such, write values 101 can be model parameters or activations of the model that are meant to be written to memory, stored as stored values 102, and then retrieved as read values 103 when they are needed for computations. Noisy memory 100 can include noise source 104 attributable to the structure or operation of the memory.

The model parameters or activations stored by write values 101 are provided to encoder neural network 110 for encoding into stored values 102 where the set of stored values has a higher dimensionality than write values 101. Stored values 102 are stored in noisy memory 100 with one stored value in each storage element of the noisy memory. Stored values 102 can then be read from the memory and provided to decoder neural network 120 which decodes them into read values 103. Encoder neural network 110 and decoder neural network 120 can be trained to assure that write values 101 and read values 103 are approximately equivalent despite the presence of noise source 104. The grid marks on write values 101 and read values 103 are used herein to indicate the number of values to be written to and read from the memory, and the grid marks on stored values 102 are meant to indicate the number of storage cells that are needed to store the stored values.

In specific embodiments of the invention, the dimensions of the stored values are higher than the dimensions of the write values and read values because the encoding is redundant. A specific encoding is learned by encoder neural network 110 to ease decoding by decoder neural network 120 in the presence of noise sources inherent in the structure or operation of noisy memory 100 such as noise source 104. When encoder neural network 110 and decoder neural network 120 form an autoencoder, stored values 102 can be described as being in the latent space of the autoencoder. The extra dimensions encoded in the latent space can store derived aspects of write values 101 including averages, statistical moments, and relationships between the values which make it easier to decode the data in the presence of noise source 104. Encoder neural network 110 and decoder neural network 120 can also learn the statistics of the noise sources that corrupt data stored in noisy memory 100. In specific embodiments, encoder neural network 110, decoder neural network 120, and noise source 104 can form a variational autoencoder with encoder neural network 110 and decoder neural network 120 being trained in a training routine with noise source 104 providing the required fluctuation in the latent space data.

In the example of FIG. 1, noisy memory 100 will be required to store more values and therefore will require more storage elements than the data would otherwise require. In the diagram, stored values 102 represent all the values that must be stored just for write values 101 in a single write operation. Those of ordinary skill will recognize that noisy memory 100 will have many more data entries than those used in a single write operation. Regardless, since noisy memory 100 may be a multi-value memory, with each storage element able to store a multi-bit value, the duplication in storage elements required for each value to be stored can be counteracted by the fact that each storage element can store multiple values. For example, if each bit of write data was expended in dimensionality by the encoder by a factor of 1.5 into the latent data space, but each storage element of the memory could store 2 bits of latent data space data, the result would be an overall increase in terms of the density of the memory on a per storage element basis. Furthermore, approaches disclosed herein can relax design constraints on memories such that the individual storage elements are more compact than alternative approaches, thereby enhancing this benefit.

An example of the benefits described in the prior paragraph is shown at the bottom of FIG. 1 with two data bits being increased in dimensionality by a factor of 1.5, but only requiring a single three-bit storage element, thereby resulting in a net density improvement over a traditional single-bit-per-storage element memory array. As illustrated, encoder neural network 110 increases a dimensionality of the write values when encoding them into the encoded write values by a factor of 1.5, and decoder neural network 120 decreases a dimensionality of the read values when decoding them into decoded read values 103 by the same factor of 1.5. As such, the dimensionality of write values 101 is equal to the dimensionality of read values 103. Furthermore, a factor by which the encoder neural network increases the dimensionality of the write values (i.e., 1.5 in this case) is less than a number of bits that can be stored in each of the storage elements (i.e., 3 in this case). In the illustrated case, since a three-bit storage element is used, there is a net decrease in the required number of storage elements despite the use of encoder neural network 110.

In specific embodiments of the invention, the memory array and any encoder neural network or decoder neural network in the system are designed so that the memory values which are denoised are multi-value analog signals. In these embodiments, decoder neural networks or encoders will perform well because the ground truth value will be closer to the noisy value as compared to when the stored values are basic binary signals. In the case of standard binary values, the impact of noise is harder for neural networks to correct for because the ground truth value may be over half the reference range from the noisy value (i.e., when the noise pushes the ground truth value just over the half-way threshold point). In contrast, with multi-value analog signals, the reference range is split into smaller segments such that neural networks have a better chance at correcting to the ground truth values.

In specific embodiments of the invention, the memory arrays disclosed herein are designed to reduce noise source from impacting the values in the memory array such that the encoder or decoder neural networks can be kept simpler and operate with fewer parameters. In the alternative or in combination, the memory arrays can be designed to emphasize the impact of gradient based noise sources on the stored values as opposed to random or popcorn noise sources. In these embodiments, the encoder or decoder neural networks will be able to learn how to counteract the noise sources with fewer parameters.

In specific embodiments of the invention, a memory is provided. The memory comprises an array of storage elements. Each storage element in the array of storage elements is a multi-value storage element. The memory also comprises an encoder neural network configured to receive write values for storage in the storage elements of the array and encode the write values into encoded write values, a write circuit configured to write the encoded write values in the storage elements in the array as stored values, a read circuit configured to read the stored values from the storage elements in the array, and a decoder neural network configured to receive read values from the read circuit and decode the read values into decoded read values.

In specific embodiments of the invention, a memory is provided. The memory comprises an array of storage elements storing stored values. Each storage element in the array of storage elements is a multi-value read only storage element. The memory also comprises a read circuit configured to read the stored values from the storage elements in the array as read values, and a decoder neural network configured to receive the read values from the read circuit and decode the read values into decoded read values. The decoder neural network decreases a dimensionality of the read values when decoding them into the decoded read values. As used herein decreasing or increasing the dimensionality of a set of data refers to decreasing or increasing the number of bits, or other values, used to represent the set of data (i.e., decreasing or increasing the cardinality of the set).

In specific embodiments of the invention, a method is provided. The method comprises providing an encoder neural network with write values, encoding, using the encoder neural network, the write values into encoded write values, and writing, using a write circuit, the encoded write values in an array of storage elements. Each storage element in the array of storage elements is a multi-value storage element and the write values are stored as stored values in the array of storage elements. The method also comprises reading, using a read circuit, the stored values from the array of storage elements as read values, and decoding, using a decoder neural network, the read values into decoded read values.

### BRIEF DESCRIPTION OF THE DRAWINGS

The accompanying drawings illustrate systems, methods, and various other aspects of the disclosure. A person with ordinary skill in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a denoising neural network including an encoder neural network and a decoder neural network which form an autoencoder to improve the performance of a noisy memory in accordance with specific embodiments of the inventions disclosed herein.

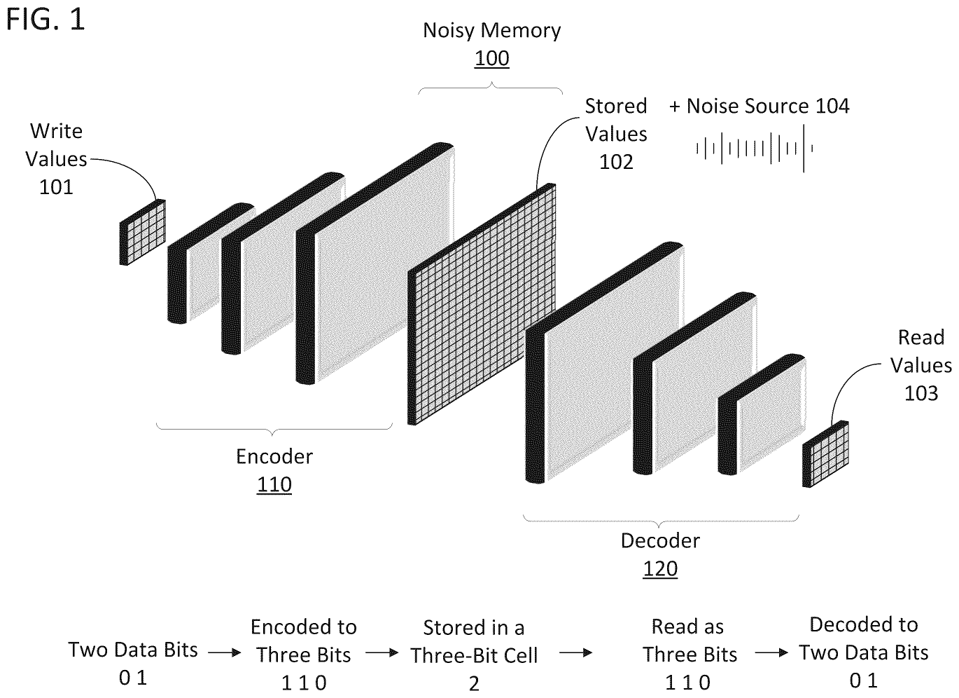

FIG. 2 illustrates a multi-value memory that includes a RAM array, an encoder neural network, and a decoder neural network, and that is in accordance with specific embodiments of the inventions disclosed herein.

FIG. 3 illustrates a multi-value memory that includes a RAM array, an encoder neural network, a decoder neural network, and integrated training circuitry, and that is in accordance with specific embodiments of the inventions disclosed herein.

FIG. 4 illustrates a multi-value memory that includes a ROM array, an encoder neural network, a decoder neural network, and integrated training circuitry, and that is in accordance with specific embodiments of the inventions disclosed herein.

FIG. 5 illustrates a multi-value memory that includes a ROM array with a decoder neural network, and that is in accordance with specific embodiments of the inventions disclosed herein.

FIG. 6 illustrates a ROM array memory cell in which potential error sources have been consolidated for training in accordance with specific embodiments of the inventions disclosed herein.

FIG. 7 illustrates a RAM array memory cell in which the memory cell includes a loop of inverters in accordance with specific embodiments of the inventions disclosed herein.

FIG. 8 illustrates a RAM array memory cell in which the memory cell includes a single access transistor in accordance with specific embodiments of the inventions disclosed herein.

FIG. 9 illustrates a flow chart of various methods for operating a memory in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Methods and systems which involve computer memories are disclosed in detail herein. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

In specific embodiments, at least one neural network circuit can be trained to assist the read circuits or the write circuits to recover noisy values from a memory array. The neural network could be trained to discern the appropriate control signals to use to write a desired value into a memory array and to read the appropriate value from that memory array. The neural network circuit could be an integrated hardware unit of the read circuits or the write circuits and be trained to learn the characteristics of the device in which it is integrated. The neural network circuit could be configured to increase or decrease a dimensionality of data into or out of a latent space with redundant values for the memory to store values which are more noise resistant. Noisy values can be read from the memory array and the neural networks can be trained to recover the true values that were meant to be stored at those memory locations. Additionally, altered values can be written to the memory array using a neural network that is trained to counteract the impact of noise from the writing and storage of information in the array. An encoding neural network can form part of the write circuits disclosed herein. A decoding neural network can form part of the read circuits disclosed herein.

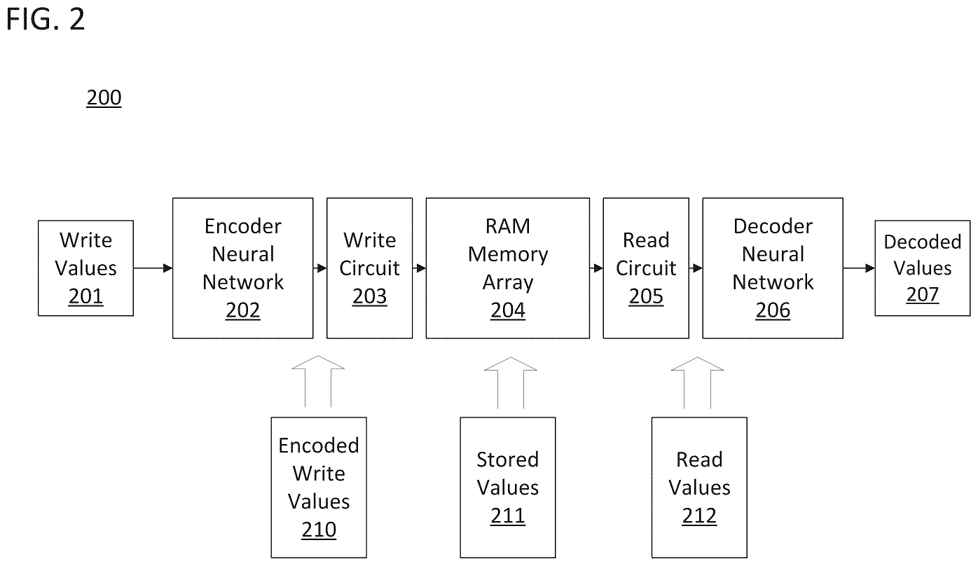

FIG. 2 illustrates multi-value memory 200 with encoder neural network 202 and decoder neural network 206. The figure illustrates a full cycle of data, in the form of write values 201, being stored in RAM memory array 204 as stored data, in the form of stored values 211, and then that data being read from RAM memory array 204 as output data, in the form of decoded read values 207. As can be seen in the figure, encoder neural network 202 can receive or be provided with write values 201 and deliver encoded write values 210 to be stored in RAM memory array 204 by write circuit 203, and decoder neural network 206 can obtain read values 212 from read circuit 205 and modify the noisy output values into denoised outputs in the form of decoded read values 207.

In specific embodiments, write values 201 and decoded read values 207 will have a lower dimensionality than stored values 211 even though all three sets of values represent the same date. This is because, in some embodiments, stored values 211 are stored in a latent data space of an autoencoder formed by encoder neural network 202 and decoder neural network 206. The approach illustrated in FIG. 2 can work well with RAM arrays that store values using analog oscillation states such as those involving patterns or pulse widths. The encoder neural network and the decoder neural network can be hardware implemented and integrated with the RAM array.

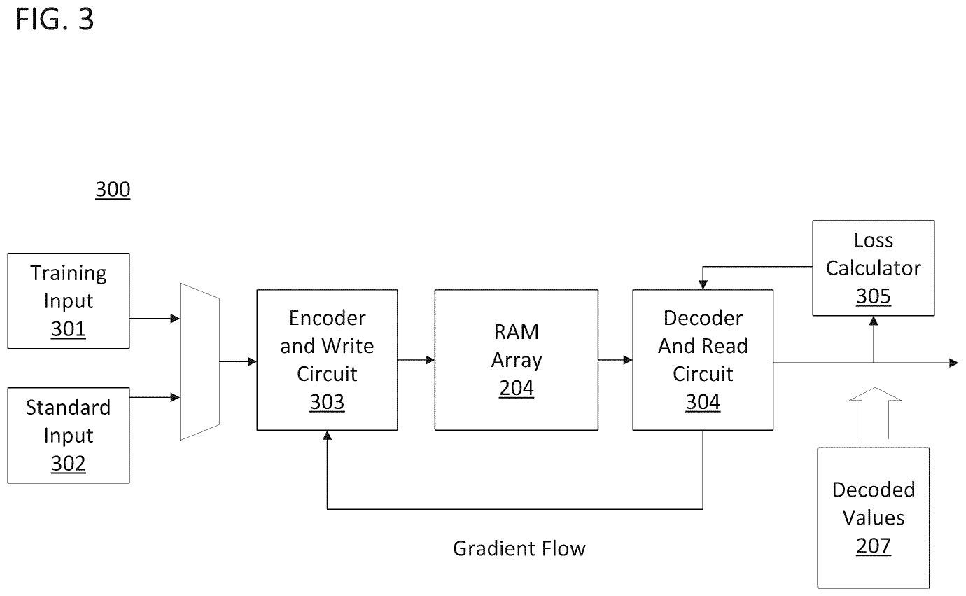

FIG. 3 illustrates memory array 300 have similar characteristics to that of FIG. 2, but with integrated training circuitry to assist in adjusting the parameters of the encoder neural network and the decoder neural network. In FIG. 3, the encoder neural network and write circuit have been combined into encoder and write circuit 303, and the decoder neural network and read circuit have been combined into decoder and read circuit 304. The integrated training circuitry includes a multiplexer to feed in either training inputs 301 from a training data input generator for the training phase of the neural network or standard inputs 302 when the device is in regular operation and is no longer being trained. As shown, the integrated training circuitry also includes loss calculator circuit 305 with knowledge of the inputs provided by training inputs 301 which can compare training inputs 301 with decoded read values 207 to determine the performance of the encoder and decoder neural networks. Loss calculator circuit 305 can then calculate a loss based on this comparison which can be used to adjust the weights, or other parameters, of the decoder neural network. The figure also shows how the loss can be fed back to the decoder neural network and the encoder neural network during training. In particular, the loss can be fed back to the encoder neural network along a gradient flow signal path that shorts RAM memory array 204 from the training path. Once trained, the weights of the encoder neural network and the decoder neural network can be fixed using ROM or any form of memory. Alternatively, the encoder and decoder neural networks can be periodically retrained in phases between operational use of the RAM to store actual normal input data.

In the illustrated case, the multi-value memory includes a RAM array. However, in alternative embodiments, the illustrated RAM array can be replaced by a ROM array, flash array, or other memory array. The encoder neural network is configured to receive write values for storage in the memory array, encode the write values into encoded write values, and store the encoded write values in the multi-value memory array. The encoder neural network can be trained on the illustrated RAM array to learn how values should be adjusted in order to provide the best chance that the true values are written to the memory, stored properly, and then retrieved at a later time. For example, the encoder neural network could determine that true values which are intended to be stored in a specific sector of the memory need to be raised by 10% of their true value when written into the memory to assure that they are properly retrieved. As another example, the encoder neural network could encode the write values in a higher dimension data space in such as a way as to make the memory more noise resistant such as by encoding relationships detected in the manner in which write values are stored in the memory array. The decoder neural network is configured to receive read values from the memory array, decode the read values into decoded read values, and provide the decoded read values as a denoised output of the multi-value memory. The decoder neural network can be trained on the illustrated RAM array to learn how values should be adjusted when read from the RAM array in order to provide the best chance that the original true values written to the memory are provided by the decoder neural network. For example, the decoder neural network could determine that values which are read from a specific sector of the memory need to be decreased by 5% of the read value when read from the memory to assure that the true values are retrieved. As another example, the decoder neural network can decode the stored values from a higher dimension space and leverage encoded relationships in the data to more accurately retrieve the values despite the existence of noise sources in the memory array. In general, the encoder neural network and decoder neural networks disclosed herein can learn some kind of relationship between the address of the memory element and an adjustment of the value to be read or stored in order to counteract the noise and error sources of the memory array and can also learn some kind of relationship between the addresses of the memory element and encode that information into the stored values.

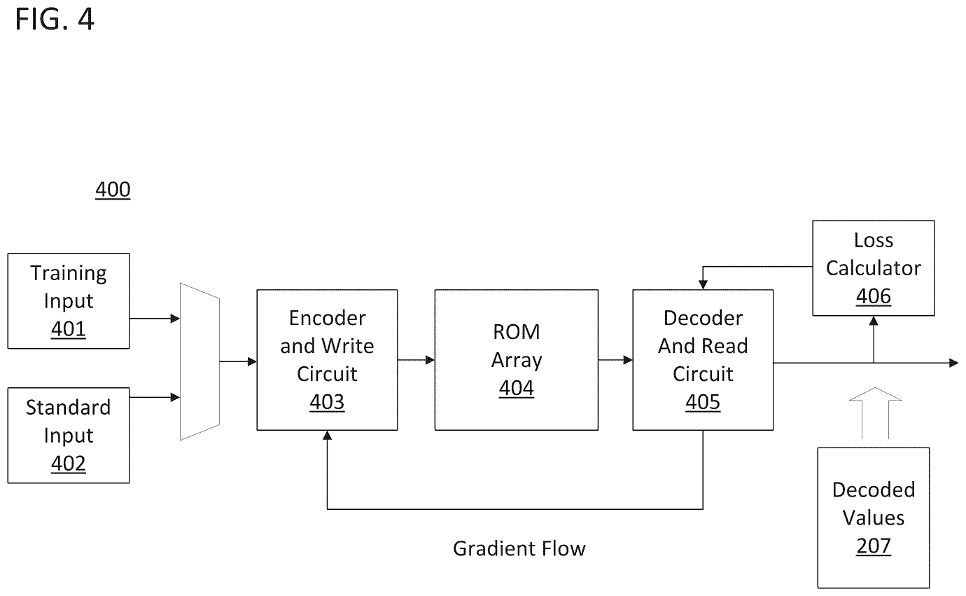

FIG. 4 illustrates memory 400 which includes ROM array 404 with similar integrated training circuitry to that of FIG. 3. In particular, the training circuitry includes a multiplexer which can pass through either training input 401 or standard input 402. The ROM array can be written to using an encoder neural network and write circuit 403 and can be read from using a decoder neural network and read circuit 405. The ROM array 404 also includes a loss calculator 406 which can calculate the loss using a comparison of decoded read values 207 and training inputs 401 and determine how to adjust the parameters of the decoder and read circuit 405 and the encoder neural network and write circuit 403. Once the ROM is programmed, the encoder neural network and write circuit 403 will no longer be required because the cells in ROM array 404 are read only at that point. However, memory 400 can still be used for various applications. For example, the encoder could be the program circuit for programming the values into ROM array 404. In such embodiments, a large number of test chips could be burned with values and the encoder could be trained using that data gleaned from reading the memory on those test chips. In the future, additional ROM arrays on different chips could then be programmed using the trained encoder. Alternatively, in such embodiments, a simulator can be included in memory 400 in parallel with ROM array 404 where the simulator simulates noisy ROM behavior of ROM array 404. The simulator can be used to train encoder neural network and write circuit 403 and then the parameters of encoder neural network and write circuit 403 could be frozen (e.g., by burning them into ROM), and only the decoder would be trained separately using the actual values programmed into ROM array 404.

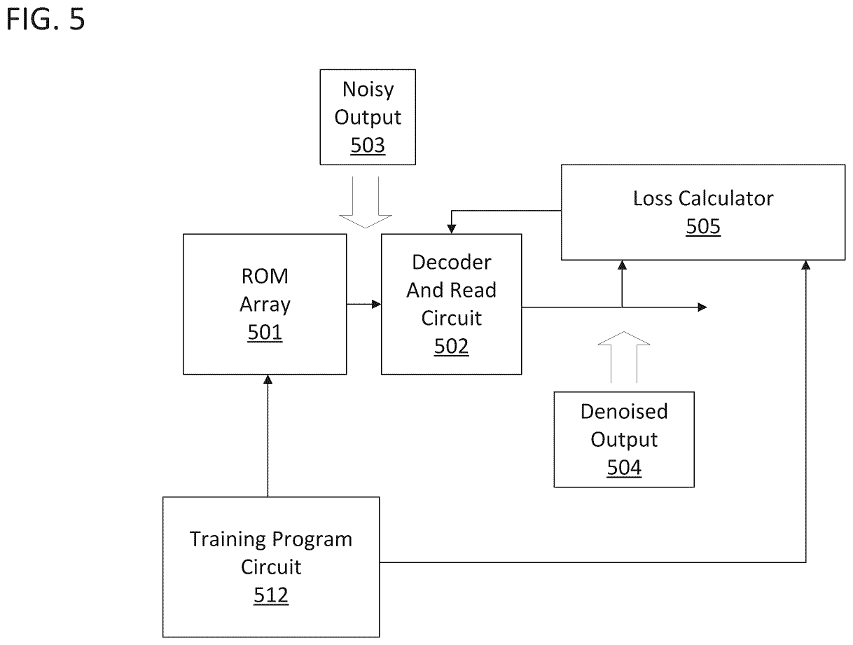

FIG. 5 illustrates a multi-value memory with a read circuit for ROM array 501 that has been augmented with decoder neural network and read circuit 502 in accordance with specific embodiments of the inventions disclosed herein. While the illustrated example shows ROM array 501, the illustrated memory array can be replaced with a RAM array, flash array, or any other kind of memory array. In specific embodiments, decoder neural network and read circuit 502 has been trained on ROM array 501 to filter out noise from ROM array 501. ROM array 501 can be a multi-value ROM array. As can be seen in the figure, decoder neural network and read circuit 502 can modify noisy output values 503 into denoised outputs 504. In specific embodiments, decoder neural network read circuit 502 can reduce a dimensionality of the stored data in ROM array 501 when reading the data in order to reduce the impact of noise on the data. The illustrated approach also shows how the neural network can be trained by supplying ground truth values to an automated test environment such as training program circuit 512 for applying test inputs to ROM array 501, and then comparing the read values of denoised outputs 504 corresponding to those stored values against the ground truth values. The term “ground truth” refers to the real values that are desired to be stored and retrieved from the memory. The difference between the two can be used in the loss function for training the neural network to denoise the outputs such as by loss calculator 505 which can adjust the parameters of the decoder neural network and read circuit 502. The neural network can learn the error sources of the memory array which allows for increasing the density of the ROM cells by storing multiple bits per cell with less concern over the impact of noise on those cells. The noise source can be attributable to the variant routing distances, storage element idiosyncrasies, differences in the conductivity of the configurable connections (e.g., fuses) between the storage transistor and bias sources, read circuit variances, and others.

The decoder neural network can be configured to receive read values from the memory array, decode the read values into decoded read values, and provide the decoded read values as a denoised output of the multi-value memory. The decoder neural network can be trained on the illustrated ROM array to learn how values should be adjusted when read from the ROM array in order to provide the best chance that the original true values that are desired to be stored in the memory are provided by the decoder neural network and read circuit 502 when read from the array. For example, the decoder neural network and read circuit 502 could determine that values which are read from a specific sector of the memory need to be decreased by 5% of the read value when read from the memory to assure that the true values are retrieved. As another example, the decoder neural network and read circuit 502 could reduce the dimensionality of the stored data when producing the decoded read values and take advantage of additional information stored in the latent space of the stored data in order to compensate for the noise sources of ROM array 501 and the read circuitry.

In specific embodiments, a decoder neural network circuit can be trained to assist the read circuits to recover noisy values from a memory array. The neural network could be trained to discern the appropriate control signals to use to read the appropriate value from that memory array. Alternatively, the neural network could be trained to adjust the manner in which the values are read. For example, the neural network may determine that values stored in a particular sector of the ROM array need to have their stored signals (e.g., charge on, voltage on, or current through a circuit element) adjusted upwards by 5% at the time they are read in order to be read appropriately. The neural network circuit could be an integrated hardware unit of the read circuits and be trained to learn the characteristics of the device in which it is integrated. Noisy values can be read from the memory array and the neural networks can be trained to recover the true values that were meant to be stored at those memory locations. The neural network can be trained to counteract the impact of noise from the writing, storage, and reading of information in the array. A decoding neural network can form part of the read circuits disclosed herein.

In specific embodiments, an encoder neural network circuit can be trained to assist the write circuits to write values to a noisy memory array such that the true values are later recovered when the values are read from the memory array. The neural network could be trained to discern the appropriate control signals to use to write the appropriate value from that memory array. Alternatively, the neural network could be trained to adjust the manner in which the values are stored. For example, the neural network may determine that values stored in a particular sector of the ROM array need to have their stored signals (e.g., charge on, voltage on, or current through a circuit element) adjusted upwards by 5% to be read appropriately at a later time. The neural network circuit could be an integrated hardware unit of the read circuits and be trained to learn the characteristics of the device in which it is integrated. The array can be noisy the neural networks can be trained to write the values into the array such that the true values that were meant to be stored at those memory locations can later be read from those memory locations. The neural network can be trained to counteract the impact of noise from the writing, storage, and reading of information in the array. An encoding neural network can form part of the write circuits disclosed herein.

The denoising neural networks disclosed herein, which include one or more of the encoder neural network and decoder neural network circuits disclosed herein, can be trained in various ways including supervised and unsupervised learning routines. Regarding supervised learning routines, a set of labeled data in the form of true values can be provided to be stored in the memory and the resulting values read from the memory can be compared to the true values as part of calculating the loss function of the learning routine. The loss can then be used in any form of backpropagation to adjust the weights of the denoising neural network.

As shown in FIG. 3, a multi-value memory can comprise a loss calculator circuit coupled to an output of the decoder neural network. The loss calculator circuit can conduct a comparison of the denoised output with a training output and calculate a loss for the encoder neural network using the comparison. The training output can be the true values that are expected from storing those values in the memory array. The true values can be supplied to the encoder neural network using a training input generator circuit. Those same values can be accessed by the loss calculator circuit and compared with the read values provided by the decoder neural network. The decoder neural network can be configured to adjust a set of weights of the decoder neural network using the loss. The decoder neural network can further be configured to adjust a set of weights of the decoder neural network via a gradient flow connection between the encoder neural network and the decoder neural network. The gradient flow connection can be a wire or bus that is capable of transmitting the backpropagation signals from the first layer of the decoder back to the encoder to be used to calculate the gradient adjustments for the weights in the final layer of the encoder neural network. The decoder neural network can be configured to pass a gradient flow input for a backpropagation weight adjustment to the encoder neural network using the gradient flow connection.

The multi-value memory can include a multiplexer to feed in training inputs from a training data input generator for the training phase of the neural network. As shown, the system can also include a training output generator and loss calculator circuit with knowledge of the inputs provided by the training data input generator. FIG. 3 also shows how the loss can be fed back to the decoder neural network during training.

As shown in FIG. 5, a multi-value memory can comprise a loss calculator circuit coupled to an output of the decoder neural network. The loss calculator circuit in this implementation is connected to an automated test environment program block in the form of training program circuit 512 that provides the true values to the ROM array for storage and provides the true values to the loss calculator circuit for training. The testing environment can ensure that the appropriate true value is applied to the loss calculator circuit when a specific memory address is read because it also controls which address the true values are stored at. This training can be conducted before or after the ROM memory has been provided with its values for storage. The automated test environment can override the stored values or can provide temporary stored values to the ROM array prior to the programming of the final values for the ROM array. The automated test environment can also utilize a portion of ROM array 501 for training which is then not used once the decoder neural network has been trained. As in FIG. 2, the output of the loss calculator circuit can be utilized by the decoder neural network for training in that the loss is used to adjust the weights of the decoder neural network.

Encoder neural network and decoder neural network circuits in accordance with this disclosure can include various elements. The circuits can include elements that are typically associated with read and write circuits for memory arrays generally such as the ability to receive an address from which data should be read or to which data should be written. The circuits can include inputs for receiving true values to be written to the memory. The circuits can include outputs on which the read values can be supplied or from which the write signals can be provided to the memory array.

The weights of the neural networks for the decoder and encoder for a multibit memory can be stored in various ways. Once trained, the weights of the decoder neural network or encoder neural network can be set for permanent use using ROM or any form of nonvolatile memory. Alternatively, the weights can be periodically retrained in phases between operational use of the multibit memory. The weights of the neural networks that set the states of the decoders and encoders can be stored in PROM memory or RAM memory and can be set after they have been trained on the multibit memory they are servicing. The memory used to store the weights can be the same type of memory or a different kind of memory from that of the memory array of the multibit memory the decoder or encoder is servicing. In specific embodiments, the memory on which the weights for the encoder and decoder are stored can be higher quality memory than that of the multibit memory and can have fewer noise sources. This memory may be larger on a per-cell basis, but it can be significantly smaller than the memory array using the approaches disclosed below. In specific embodiments, the memory for the weights of the decoder and encoder can be less than 10% of the size of the overall multibit memory. The memory used to store the weights for the encoder, decoder, or encoder and decoder can be referred to as the parameter memory array to distinguish it from the memory array the decoder or encoder are servicing.

The parameters of any of the encoder neural networks and decoder networks disclosed herein can be trained in multiple phases. For example, the parameters of the neural networks can be trained once generally based on the characteristics of a specific memory design, and the parameters can then be fine tuned for specific parts once a given chip has been fabricated. Light weight fine-tuning approaches can be used to tune the parameters. Lightweight fine-tuning of trained neural networks, like the LORAN (Low-Rank Adaptation Network) approach, can be used to modify only a small subset of the parameters, thereby reducing computational costs and memory usage. The techniques can involve fine-tuning low-rank matrices or subsets of layers within the network, rather than adjusting all the weights. This allows the encoders and decoders to adapt to the noise sources that are inherent in a given chip with minimal changes, preserving the original performance while incorporating new information. Additionally, methods like parameter-efficient fine-tuning (PEFT) and adapter modules can also be employed, where small modules are added to the original encoder or decoder and trained, leaving the majority of the pre-trained parameters of the original encoder or decoder untouched. These approaches enable efficient resource utilization and faster training times, making them suitable for deployment in resource-constrained environments.

The encoder neural network and decoder neural network can also have logic or arithmetic circuitry that calculates the encoded or decoded values based on the inputs to the encoder or decoder and the stored weights. The encoder neural network and decoder neural network can also have logic or arithmetic circuitry that implements the encoded or decoded values based on the inputs to the encoder or decoder and the stored weights. The encoder neural network and the decoder neural network can use the logic or arithmetic circuitry to execute a neural network with the values for or from the memory as inputs and the weights of the neural network as the weights. The outputs of the neural networks can then either be the denoised values (in the case of the decoder) or the encoded true values for storage in the memory (in the case of the encoder). The outputs of the neural networks can alternatively be the result of a computation indicating how much the true values or encoded true values from the memory need to be modified to result in the encoded values for storage or the recovered true values respectively.

In specific embodiments of the invention, at least one of an encoder neural network and a decoder neural network are integrated on the same integrated circuit as the memory array. In specific embodiments, the memory array is also integrated with a processor. The parameters for the encoder neural network and the encoder neural network can be stored in a read only memory or a random-access memory. The read only memory and the multi-value memory can be integrated on a single substrate. The read only memory can have single value memory cells. The read only memory can be less than ten percent of the size of the multi-value memory.

In specific embodiments, the memory array can be a RAM where each memory cell in the RAM comprises a loop of inverters and that is integrated with a processor. The processor can conduct computations using a set of logic transistors. The loops of inverters can be formed by a set of inverter transistors. The set of logic transistors and the set of inverter transistors can be formed using a common process flow.

In specific embodiments, the memory array can be a ROM where each memory cell includes an access transistor and may also include a storage transistor where the connectivity or conductivity state of the storage transistor represents the value stored by the memory cell. Each memory cell can be a multibit cell as the access or storage transistors can be programmed into multiple connectivity or conductivity states. The memory array can be integrated with a processor. The processor can conduct computations using a set of logic transistors. The access transistor, and the storage transistor if present, can be formed using a common process flow with the set of logic transistors. Integration of the ROM with processing circuitry can be assisted in these embodiments because the noise cancelling effect of the neural networks will enable the bit, word, and supply lines of the ROM to be less uniform than in standard ROM circuits which would enable the layout of the ROM to be more conformal to the required layout of the processing circuitry.

In specific embodiments of the invention, a multi-value memory can be provided in which error and noise sources have been consolidated or otherwise reduced in such a way that the number of parameters required for an encoder neural network, a decoder neural network, or a decoder and encoder neural network to effectively reduce the impact of the error and noise sources can be limited. In specific embodiments a multi-value memory is provided comprising a multi-value read only memory array, wherein the read only memory is configured such that each memory cell in the multi-value read only memory array can be read by one of: a charge sharing operation; and a steady state current measurement operation. The multi-value memory can then further comprise a decoder neural network configured to receive read values from the memory array, decode the read values into encoded read values, and provide the encoded read values as a denoised output of the multi-value memory. In these embodiments, the charge sharing operation can be between a reference voltage connected on one side of an access transistor in a memory cell of the multi-value memory and the steady state current measurement operation can be conducted on one side of an access transistor in a memory cell that is connected to a reference current on the opposite side.

In specific embodiments of the invention, the multi-bit memories are designed so that the noise sources follow a gradient across the array, such as in the case of process variations across a memory array, and so that the noise sources do not follow a random location or popcorn noise distribution. In these approaches, the variance of individual transistors in terms of their characteristics or their individual routing paths within the memory array do not impact the value of the memory that is stored and read from the memory array.

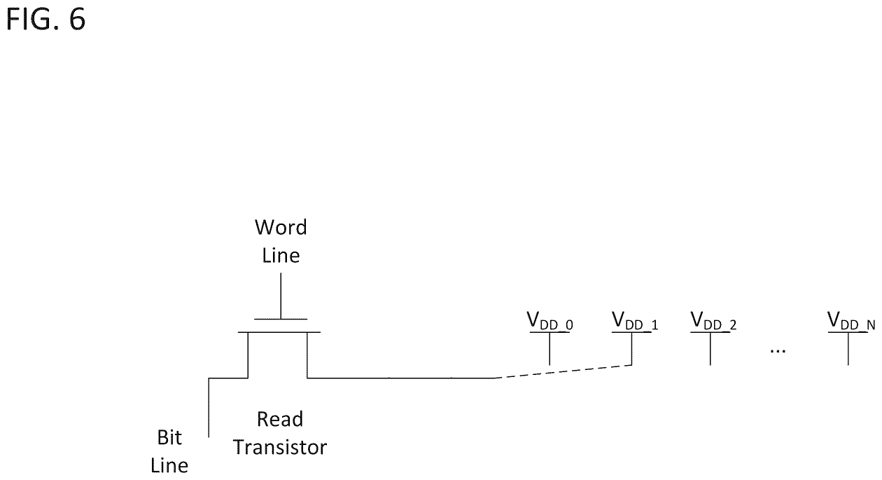

FIG. 6 illustrates a ROM array memory cell in which potential error sources have been consolidated for training in accordance with specific embodiments of the inventions disclosed herein. The memory cell in FIG. 6 is programmed by connecting the drain of the transistor to different reference voltages and is read by measuring a voltage on the bit line that results after the word line voltage goes high to turn on the read transistor and the capacitance of the bit line charges up. As such, in approaches such as those in FIG. 6, the connectivity state of the transistor and the associated value stored thereby can be read definitively using a charge sharing circuit such that the idiosyncrasies of the individual storage transistors do not need to be learned by the neural network. In particular, the on resistance and threshold voltages of the read transistors do not contribute to the voltage that the capacitor, which is the bit line, is charged to in the charge sharing operation. As such, the variances in those values from one memory cell to the other across the memory array do not need to be learned by the neural networks.

In specific embodiments of the invention, a multi-value memory is provided wherein the multi-value memory array is a RAM array comprising an array of memory cells and each memory cell in the array of memory cells comprises a loop of inverters. The RAM array can be integrated with a processor. The processor can conduct computations using a set of logic transistors. The loop of inverters can be formed by a set of inverter transistors. The set of logic transistors and the set of inverter transistors are formed using a common process flow. The multi-value memory can also comprise a decoder neural network configured to receive read values from the memory array, decode the read values into encoded read values, and provide the encoded read values as a denoised output of the multi-value memory. The multi-value memory can also comprise an encoder neural network configured to receive write values for storage in the memory array, encode the write values into encoded write values, and store the encoded write values in the multi-value memory array.

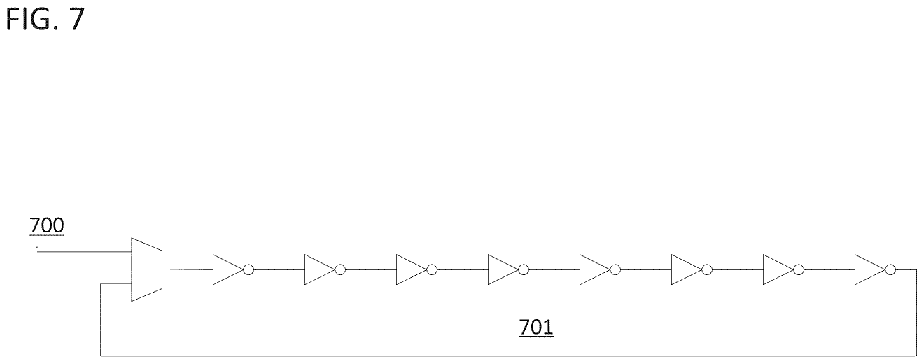

FIG. 7 illustrates a RAM array memory cell in which the memory cell includes a loop of inverters in accordance with specific embodiments of the inventions disclosed herein. The loop of inverters stores the value of the memory cell in either a pattern of pulses or a pulse width of a pulse that is oscillating through the ring of inverters. The loop of inverters can be programmed by forcing a value on node 700 which will create a pattern of pulses to loop through node 701. The ring of inverters can be formed by transistors that are formed using the same process as the processor transistors for the processor that the RAM array is servicing. As such, the RAM array can be tightly integrated with the processing circuitry of the processor. Furthermore, using an encoder neural network, a decoder neural network, or an encoder neural network and a decoder neural network in accordance with this disclosure, the RAM can be even more tightly integrated as it will be less susceptible to the noise that would otherwise be generated by an irregular layout for a RAM array. The devices that form the loop of inverters can also be smaller and designed less stringently in terms of their layout when used in combination with such neural networks.

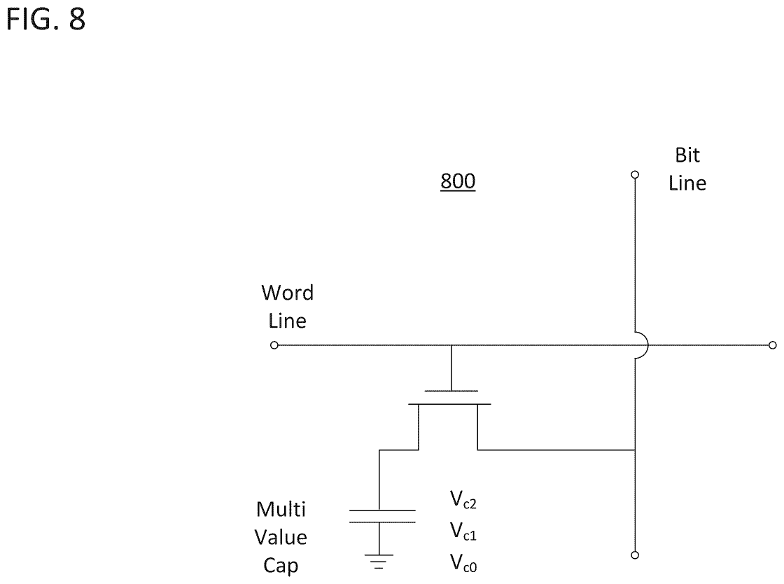

In specific embodiments of the invention, the noisy memory arrays disclosed herein can be any form of multi-value memory array with storage elements that can store multi-bit values. For example, the storage elements could be multi-bit DRAM cells such as RAM cell 800. As illustrated in FIG. 8, RAM cell 800 includes a single access transistor with its gate connected to a word line, source connected to a bit line, and drain connected to a storage capacitor. RAM cell 800 can be programmed to different values by putting different amounts of charge on the storage capacitor. Reading a value from the multi-bit memory cell would then involve sensing the amount of charge that was stored on the capacitor using a read circuit coupled to the bit line when the word line was driven high.

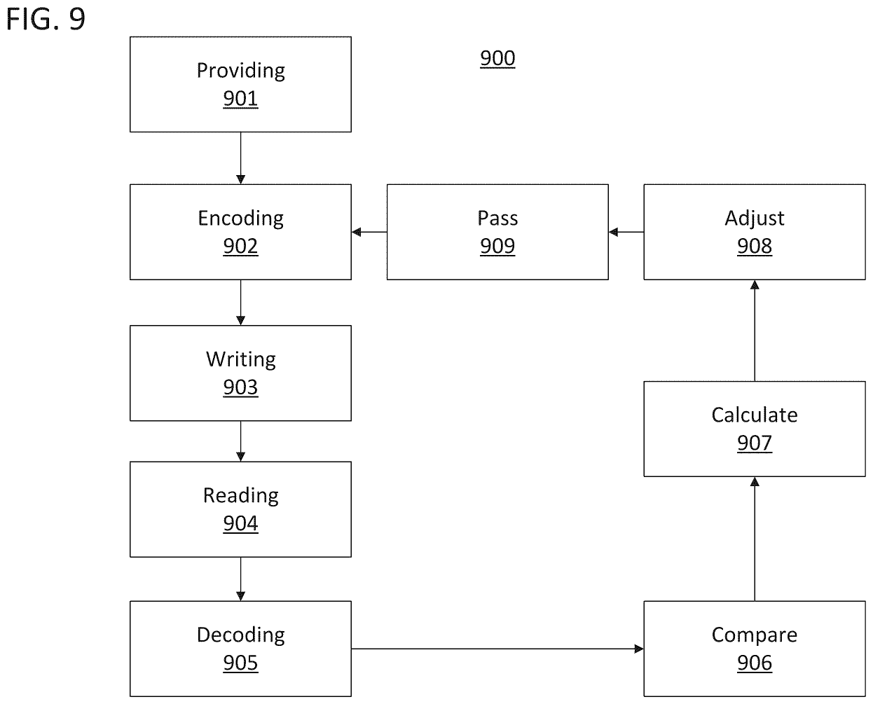

FIG. 9 illustrates flow chart 900 of various methods for operating a memory in accordance with specific embodiments of the inventions disclosed herein. Flow chart 900 includes a step 901 of providing an encoder neural network with write values. The values could be values that are intended to be stored in a memory or they could be values intended to be used to help in training the encoder neural network or a decoder neural network with which the encoder neural network is paired. Flow chart 900 also encodes a step 902 of encoding, using the encoder neural network, the write values into encoded write values. This step can include adjusting the individual values and may include increasing a dimensionality of the write values in generating the encoded write values. These steps are optional steps, as not all the embodiments disclosed herein include an encoder neural network. As such, they can be skipped, and the method can begin with a step of writing a value to the memory or programming values into a read only memory.

Flow chart 900 also includes a step 903 of writing, using a write circuit, the encoded write values in an array of storage elements. Each storage element in the array of storage elements is a multi-value storage element and the write values are stored as stored values in the array of storage elements. The step can involve applying different voltage, currents, or other signals to the storage elements in order to store a specific analog value in the storage element from an amount a set of potential values. In specific embodiments, the step can be replaced with a step of programming values into a ROM memory.

Flow chart 900 continues with a step 904 of reading, using a read circuit, the stored values from the array of storage elements as read values. The step can include applying certain control signals to the array of storage elements to sense the analog values stored therein and to translate the multi-value analog signals into multi-bit digital signals. Flow chart 900 also includes a step 905 of decoding, using a decoder neural network, the read values into decoded read values. The step can include changing the individual values. The step can also involve reducing a dimensionality of the stored values when converting them into decoded read values. The step can be conducted to reduce the impact of noise sources on the stored values. The dimensionality of the write values can be equal to a dimensionality of the decoded read values. The write values can be written into a set of addresses in the array and the read values can be read from those same addresses (e.g., the decoded read values can be the same data as the original write values after those values were encoded, written to the memory, stored in the memory, read from the memory, and decoded). The multi-value storage elements can store a number of bits per storage element in that they can store multiple analog values that correspond with more than two states. In specific embodiments, a factor by which the encoder neural network increases the dimensionality of the write values can be less than a number of bits that can be stored in each of the storage elements.

Flow chart 900 continues with a step 906 of comparing, using a loss calculator circuit coupled to an output of the decoder neural network, a comparison of the decoded read values with a training output. The step can involve a basic subtraction of one set of values vs the other to obtain a comparison. The flow chart 900 continues with a step 907 of calculating, using the loss calculator circuit and the comparison, a loss for the encoder neural network. The loss can be proportional to the comparison. The loss can be proportional to an absolute value of the comparison. The loss can also be calculated differently for different portions of the memory. The loss can be a function of both the addresses from which the values were read and the differences in the values. The loss function can be an array of numbers with the position in the array relating to the addresses of the memory and the values in the array being proportional to the comparison. The values in a given position in the array can correspond with the addresses from which a read value was obtained for calculating the comparison.

Flow chart 900 also includes a step 908 of adjusting a set of weights of the decoder neural network using the loss. This step can be conducted in association with standard approaches for machine learning such as gradient descent. Gradient descent adjusts the weights by computing the gradient of the loss function with respect to each parameter, then moving in the opposite direction of the gradient to minimize the loss. Various versions of gradient descent can be used such as stochastic gradient descent (SGD), which updates parameters using a single or a small batch of training examples, and mini-batch gradient descent, which strikes a balance between SGD and full-batch methods. Other approaches that can be used include optimization algorithms such as AdaGrad, which adapts the learning rate for each parameter based on the historical gradients, RMSprop, which addresses AdaGrad's diminishing learning rates by using a moving average of squared gradients, and Adam, which combines the advantages of AdaGrad and RMSprop by computing adaptive learning rates for each parameter and incorporating momentum. Flow chart 900 also includes a step 909 of passing a gradient flow input for a backpropagation weight adjustment to the encoder neural network from the decoder neural network using a gradient flow connection. This step can involve an extension of standard backpropagation. Alternatively, this step can involve skip connections, with connections added from the encoder directly to the decoder, allowing gradients to flow more easily and reducing the risk of vanishing gradients. Alternatively, approaches used for variational autoencoder (VAE) can be utilized to help updating the parameters of the neural networks (e.g., weight adjustment) by introducing a probabilistic framework, where the encoder produces parameters for a probability distribution, and the decoder samples from this distribution, facilitating gradient flow. The probability distribution can be injected into the training routine or it can be part of the noise sources of the memory array. Regularization methods like adding noise to the input or using dropout can also aid in maintaining robust gradient flow, ensuring the encoder and decoder learn complementary representations efficiently.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be memory within a personal user device or a network accessible memory. Although examples in the disclosure were generally directed to artificial intelligence accelerators, the same approaches could be utilized for any computing architecture with large memory requirements including those directed to cryptographic processing, graphics processing, and high-performance computing generally. The memory arrays in accordance with this disclosure can be read only memories, random access memories, flash memories, phase change memories, or any other memory technology. Approaches disclosed herein can also be applied to the transmission of noisy multi-level values over links in a processing system both on chip and off chip in which neural networks are used to assure that exact values are recovered at the destination. In these embodiments, the link can take the place of the memory arrays disclosed herein and there may be an encoder on the transmission side of the link and/or a decoder on the receiver side of the link. These and other modifications and variations to the present invention may be practiced by those skilled in the art, without departing from the scope of the present invention, which is more particularly set forth in the appended claims.

What is claimed is:

1. A memory comprising:
an array of storage elements, wherein each storage element in the array of storage elements is a multi-value storage element;
an encoder neural network configured to receive write values for storage in the storage elements of the array and encode the write values into encoded write values;
a write circuit configured to write the encoded write values in the storage elements in the array as stored values;
a read circuit configured to read the stored values from the storage elements in the array; and
a decoder neural network configured to receive read values from the read circuit and decode the read values into decoded read values.

2. The memory of claim 1, wherein:
the encoder neural network increases a dimensionality of the write values when encoding them into the encoded write values;
the decoder neural network decreases a dimensionality of the read values when decoding them into the decoded read values; and
the dimensionality of the write values is equal to a dimensionality of the decoded read values.

3. The memory of claim 2, wherein:
a factor by which the encoder neural network increases the dimensionality of the write values is less than a number of bits that can be stored in each of the storage elements.

4. The memory of claim 1, further comprising:
a loss calculator circuit coupled to an output of the decoder neural network;
wherein the loss calculator circuit conducts a comparison of the decoded read values with a training output and calculates a loss for the decoder neural network using the comparison.

5. The memory of claim 4, wherein:
the decoder neural network is configured to adjust a set of weights of the decoder neural network using the loss.

6. The memory of claim 1, further comprising:
a gradient flow connection between the encoder neural network and the decoder neural network;
wherein the decoder neural network is configured to pass a gradient flow input for a backpropagation weight adjustment to the encoder neural network using the gradient flow connection.

7. The memory of claim 1, wherein:
a set of parameters that define the encoder neural network and the encoder neural network are stored in a read only memory;
the read only memory and the memory are integrated on a single substrate;
the read only memory has single value memory cells; and
a size of the read only memory is less than ten percent of a size of the memory.

8. The memory of claim 1, wherein:
the encoder neural network and the decoder neural network form an autoencoder.

9. The memory of claim 1, wherein:
the memory includes a noise source; and
the encoder neural network, the noise source, and the decoder neural network form a variational autoencoder.

10. The memory of claim 1, wherein:
the array of storage elements is a random access memory array; and
each storage element in the array of storage elements comprises a loop of inverters.

11. The memory of claim 10, wherein:
the memory is integrated with a processor;
the processor conducts computations using a set of logic transistors;
the storage elements are each formed by a set of inverter transistors; and
the set of logic transistors and the set of inverter transistors are formed using a common process flow.

12. A memory comprising:
an array of storage elements storing stored values, wherein each storage element in the array of storage elements is a multi-value read only storage element;
a read circuit configured to read the stored values from the storage elements in the array as read values; and
a decoder neural network configured to receive the read values from the read circuit and decode the read values into decoded read values;
wherein the decoder neural network decreases a dimensionality of the read values when decoding them into the decoded read values.

13. The memory of claim 12, further comprising:
an encoder neural network configured to receive write values for storage in the storage elements of the array and encode the write values into encoded write values; and
a program circuit configured to program the encoded write values in the storage elements in the array as the stored values;
wherein: (i) the encoder neural network increases a dimensionality of the write values when encoding them into the encoded write values; and (ii) the dimensionality of the write values is equal to a dimensionality of the decoded read values.

14. A method comprising:
providing an encoder neural network with write values;
encoding, using the encoder neural network, the write values into encoded write values;
writing, using a write circuit, the encoded write values in an array of storage elements, wherein each storage element in the array of storage elements is a multi-value storage element and the write values are stored as stored values in the array of storage elements;
reading, using a read circuit, the stored values from the array of storage elements as read values; and
decoding, using a decoder neural network, the read values into decoded read values.

15. The method of claim 14, wherein:
the encoder neural network increases a dimensionality of the write values when encoding them into the encoded write values;
the decoder neural network decreases a dimensionality of the read values when decoding them into the decoded read values; and
the dimensionality of the write values is equal to a dimensionality of the decoded read values.

16. The method of claim 15, wherein:
a factor by which the encoder neural network increases the dimensionality of the write values is less than a number of bits that can be stored in each of the storage elements.

17. The method of claim 14, further comprising:
comparing, using a loss calculator circuit coupled to an output of the decoder neural network, a comparison of the decoded read values with a training output; and
calculating, using the loss calculator circuit and the comparison, a loss for the decoder neural network.

18. The method of claim 17, further comprising:
adjusting a set of weights of the decoder neural network using the loss.

19. The method of claim 14, further comprising:
passing a gradient flow input for a backpropagation weight adjustment to the encoder neural network from the decoder neural network using a gradient flow connection.

20. The method of claim 14, wherein:
a set of parameters for the encoder neural network and the encoder neural network are stored in a read only memory;
the read only memory and the array of storage elements are integrated on a single substrate;
the read only memory has single value memory cells; and
a size of the read only memory is less than ten percent of a size of the array of storage elements.

21. The method of claim 14, wherein:
the encoder neural network and the decoder neural network form an autoencoder.

22. The method of claim 14, wherein:
the array of storage elements includes a noise source; and
the encoder neural network, the noise source, and the decoder neural network form a variational autoencoder.

23. The method of claim 14, wherein:
the array of storage elements is a random access memory; and
each storage element in the array of storage elements comprises a loop of inverters.

24. The method of claim 23, wherein:
the random access memory is integrated with a processor;
the processor conducts computations using a set of logic transistors;
the storage elements are formed by a set of inverter transistors; and
the set of logic transistors and the set of inverter transistors are formed using a common process flow.
